(19) United States
(12) Patent Application Publication
(10) Pub. No.: US 2011/0026055 A1
(43) Pub. Date: Feb. 3, 2011

(54) IMAGE FORMATION APPARATUS

(75) Inventor: Yasunori Sato, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/844,157

(22) Filed: Jul. 27, 2010

(30) Foreign Application Priority Data
Jul. 28, 2009 (JP) 2009-175566

(51) Int. Cl. H04N 1/60

(52) U.S. Cl. 358/1.9

(57) ABSTRACT

According to one embodiment, an image formation apparatus includes storage, an image formation unit, an attribute change acceptance unit, and an image converter. The storage stores image data of multiple pages of document. The image formation unit reads the image data from the storage, and forms an image of the read image data on a recording medium. The attribute change acceptance unit accepts a change in attribute information for forming images of continued pages of document on a recording medium. The image converter converts the image data stored in the storage, based on contents of the attribute information accepted by the attribute change acceptance unit.

### CROSS-REFERENCE TO RELATED APPLICATIONS

This application is based upon and claims the benefit of priority from Japanese Patent Application No. 2009-175566, filed Jul. 28, 2009; the entire contents of which are incorporated herein by reference.

### FIELD

Embodiments described herein relate generally to an image formation apparatus of a Multi Functional Peripheral (MFP) or printer.

### BACKGROUND

Conventionally, the following image formation apparatus is known in the art. The image formation apparatus stores requested image data in storage without forming an image. The apparatus collectively forms images of multiple image data stored in storage.

The apparatus saves energy by decreasing the number of switching operations between image formation and standby.

Recently, it is recommended to use double-sided printing and N-up printing from the viewpoint of efficient use of recording media resources. In double-sided printing, images of continued pages of document are alternately formed on a first or front side and a second or back of a recording medium. In N-up printing, images of continued pages of document are reduced, and the reduced images are collectively formed on one side of a recording medium divided into two or four sections.

Double-sided or N-up printing is generally set before image data is created, and image data is created based on the setting. In other words, when double-sided printing is set, image data is created so that images of continued pages of document are alternately printed on first and second sides of a recording medium. When N-up printing is set, image data is created so that images of continued pages of document are reduced, and the reduced images are collectively formed on one side of a recording medium.

Created image data is stored in storage. In the case of double-sided printing, an image formation apparatus sequentially reads image data of each page from storage. The apparatus forms images alternately on first and second sides of a recording medium. In the case of N-up printing, an image formation apparatus sequentially reads image data of each page from storage. The apparatus forms images separately on one side of a recording medium.

Therefore, after storing image data in storage, a conventional image formation apparatus cannot change one-side printing to double-sided printing. Similarly, it is impossible to change standard size printing to N-up printing.

Thus, if image formation is requested without setting double-side or N-up printing, the user must once cancel the image formation request.

An image formation apparatus, which can change a printing method after image formation is requested, is desired.

### BRIEF DESCRIPTION OF THE DRAWINGS

FIG. 1 is a block diagram showing a configuration of essential components of a MFP according to an embodiment;

FIG. 2 is a plan view of an operation panel of the MFP;

FIG. 3 is a diagram showing a structure of job management data stored on a management table of the MFP;

FIG. 4 is a flowchart of essential steps of a job confirmation process executed by a CPU of the MFP;

FIG. 5 shows an example of a job list screen;

FIG. 6 shows an example of a job setting change screen;

FIG. 7 shows changes of image data when changing to 2-up printing is executed; and

FIG. 8 shows changes of image data when changing to double-sided printing is executed.

### DETAILED DESCRIPTION

In general, according to one embodiment, an image formation apparatus includes storage, an image formation unit, an attribute change acceptance unit, and an image converter. The storage stores image data of multiple pages of document. The image formation unit reads the image data from the storage, and forms an image of the read image data on a recording medium. The attribute change acceptance unit accepts a change in attribute information for forming images of continued pages of document on a recording medium. The image converter converts the image data stored in the storage, based on the contents of the attribute information accepted by the attribute change acceptance unit.

An image formation apparatus according to one embodiment, incorporated in a MFP 1, will be explained hereinafter with reference to the accompanying drawings.

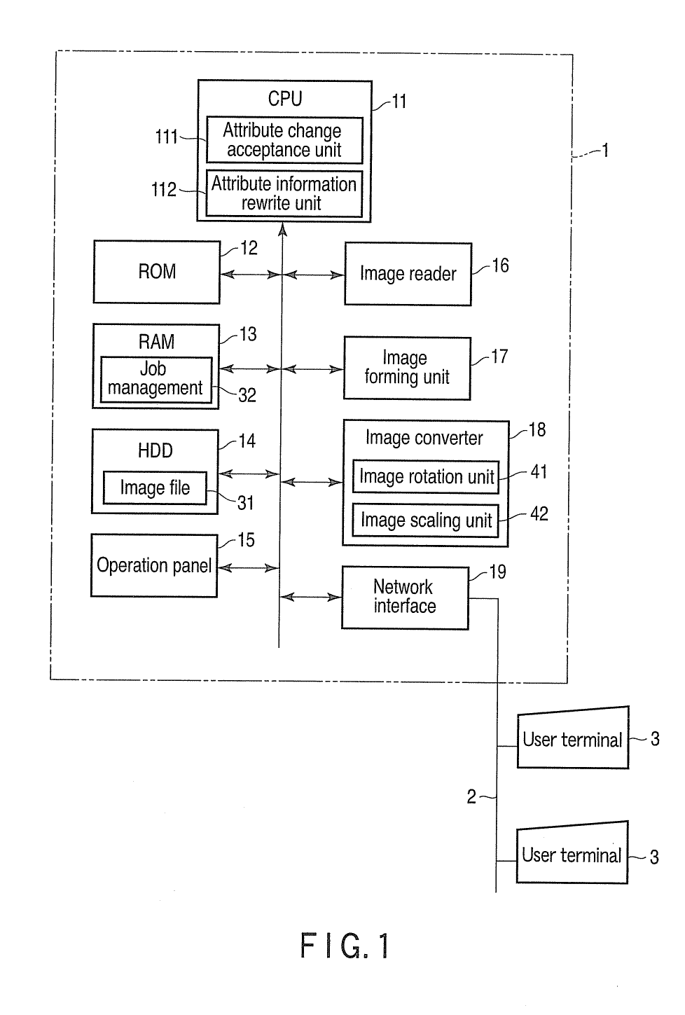

FIG. 1 is a block diagram showing a configuration of essential components of the MFP 1. The MFP 1 is provided with a central processing unit (CPU) 11 as a main controller. The CPU 11 connects with a read only memory (ROM) 12, a random access memory (RAM) 13, a hard disk drive (HDD) 14, an operation panel 15, an image reader 16, an image formation unit 17, an image converter 18, and a network interface 19, through bus lines such as an address bus and data bus.

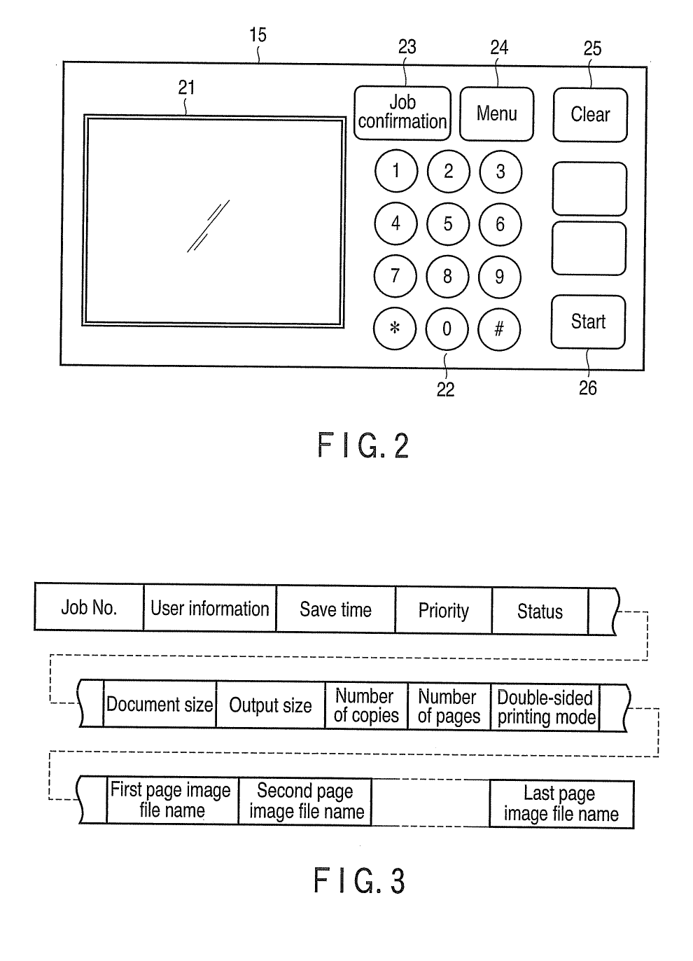

The operation panel 15 is provided on the top face of the main body of the MFP 1. As shown in FIG. 2, a touch-panel display 21, a ten-key 22, and function buttons are provided on the operation panel 15. The function buttons include at least a job confirmation button 23, a menu button 24, a clear button 25, and a start button 26.

The image reader 16 has a scanner. The image reader 16 reads an image included in document placed on a document table by the scanner, converts the image into an image signal, and outputs the image signal. The output image signal is saved as image data in an image file 31 of the HDD 14.

The image formation unit 17 forms an electrophotographic image. In other words, the image formation unit 17 forms a toner image on a recording medium such as paper, based on the image data saved in the image file 31, and fixes the toner image on a recording medium by a heat-fixing unit.

The image converter 18 converts the image data saved in the image file 31, by using an image rotation unit 41 and an image scaling unit 42. The image rotation unit 41 rotates the image data 90° clockwise, 90° counter-clockwise, or 180°. The image scaling unit 42 enlarges or reduces image data by specified scaling factors.

The network interface 19 controls data communication between the MFP 1 and user terminals 3 connected through a network 2 such as a local area network (LAN).

A user terminal 3 is a personal computer having functions of creating and editing a document file, for example. When a user of a terminal 3 instructs to print a document file, the terminal 3 creates image data from the data of the document file. The terminal 3 transmits a print job command including the image data, to the MFP 1 through the network 2.

Receiving the print job command, the MFP 1 saves the image data included in the command in an image file 31 of the HDD 14. Further, the MFP 1 creates a job management data based on the data of the command. The MFP 1 stores the job management data in a job management table 32 of the RAM 13.

As shown in FIG. 3, job management data comprises a job number, user information, save time, priority, status, a document size, an output size, the number of copies, the number of pages, double-sided printing mode, and image file names for each page. After an image of corresponding image data is formed, the job management data is cleared from the job management table 32.

A job number is a unique number assigned to data whenever job management data is created from a print job command.

User information is a user name of a user terminal 3, which is a print job command transmission source.

Save time is a point of time when the image data managed by the job management data is a stored in the image file 31.

Priority is priority of printing. Priority is set in the following four steps [1] to [4], for example.

Priority [1]: First priority, output immediately.

Priority [2]: Output after a lapse of desired time A.

Priority [3]: Output after a lapse of desired time B. (B>A)

Priority [4]: Output after a lapse of desired time C. (C>B)

Status indicates that the image data is processed or not processed. In this embodiment, the status “1” indicates that the image data is not processed, and “0” indicates that the image data is processed.

A document size is a paper size of image data of one page of a source document. An output size is a paper size of a recording medium to form an image. The number of copies is the number of prints. The number of pages is the number of pages of a document constituting image data.

Double-sided printing mode indicates double-sided printing or one-side printing. The mode “1” indicates one-side printing, and “0” indicates double-sided printing.

An image file name for each page is a file name assigned to document image data of a corresponding page.

The MFP 1 specifies image data to collectively form images, in accordance with the priority of job management data created for each image data stored in the image file 31. The MFP 1 sequentially reads the image data to collectively form images from the image file 31. The image formation unit 17 forms an image corresponding to the read image data on a recording medium. This function is described in detail in Jpn. Pat. Appln. KOKAI Publication No. 2001-026163 by the same applicant, and an explanation thereof is omitted.

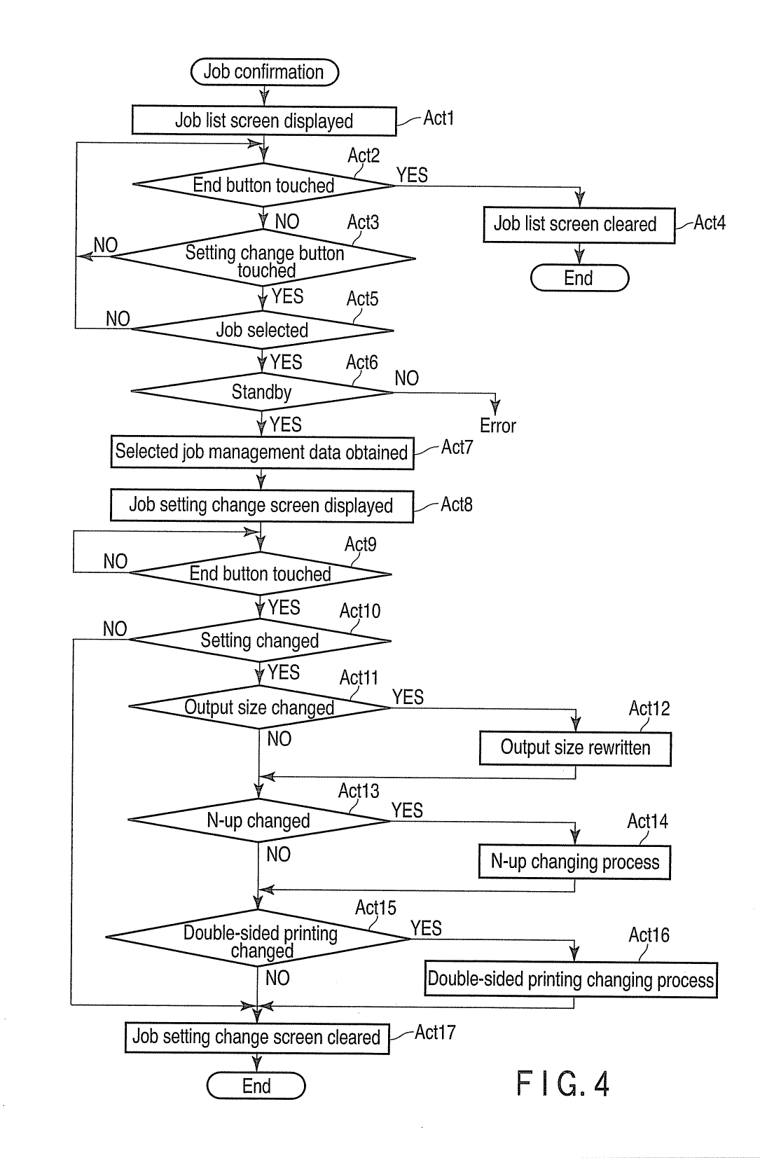

Further, the MFP 1 has a job confirmation function. This function is realized by the CPU 11 by executing a job confirmation process shown as a flowchart in FIG. 4, according to a job confirmation program stored in the RON 12, for example.

In other words, the CPU 11 detects depression of the job confirmation button 23, and starts the job confirmation process. First, the CPU 11 creates a job list screen 50 based on the job management data stored in the job management table 32. The CPU 11 displays the screen on the display 21 (Act 1).

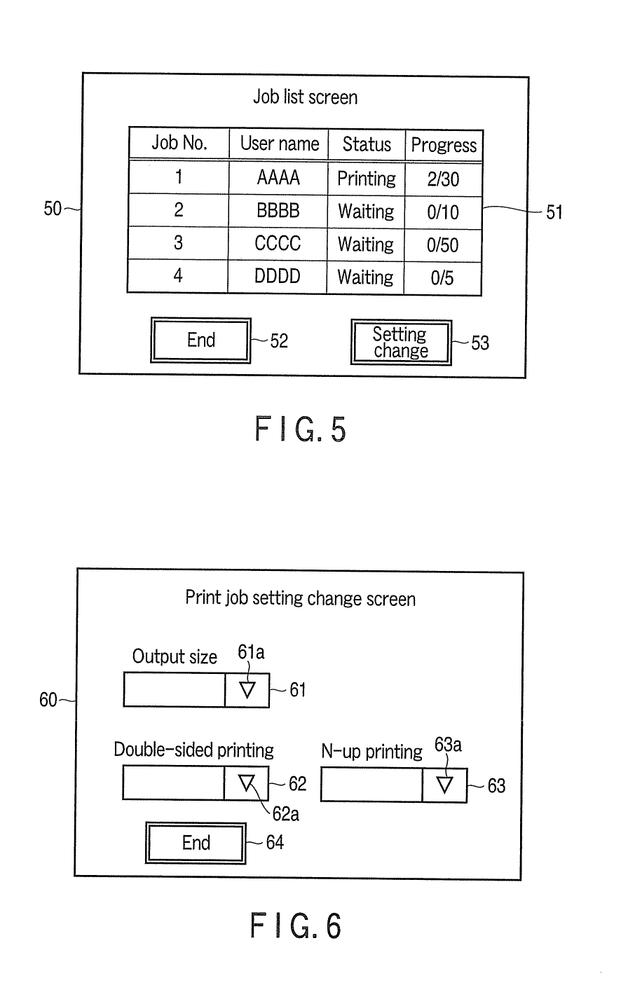

FIG. 5 shows an example of the job list screen 50. As shown in FIG. 5, the job list screen 50 has a job management list 51, an end button 52, and a setting change button 53. One line of the job management list 51 displays a job number of job management data, user information (a user name), and status. Progress of a print job is also displayed in the same line.

In the status of the job management list 51, “Standby” indicates that an image of the image data managed by the indicated job number is not formed, and the image data is being saved in the image file 31. In this case, “0/page” is indicated as progress data. “Printing” indicates that an image of the image data managed by an indicated job number is being formed. In this case, “Image completed page/total pages” is indicated as progress data.

After displaying the job list screen 50, the CPU 11 waits until the end button 52 is touched (Act 2), or the setting change button 53 is touched (Act 3). When the end button 52 is touched (YES in Act 2), the CPU 11 clears the job list screen 50 (Act 4). This completes the job confirmation process.

When the setting change button 53 is touched (YES in Act 3), the CPU 11 determines whether an object print job is selected (Act 5).

When any line of the job management list 51 is touched before the setting change button is touched, the print job of the job number displayed in that line is selected as an object print job. Otherwise, no print job is selected as an object. When no print job is selected as an object (NO in Act 5), the CPU 11 returns to the state waiting until the end button 52 or setting change button 53 is touched (Act 2 or 3).

When an object print job is selected (YES in Act 5), the CPU 11 determines whether the status of the selected print job is standby (Act 6). When the status is not standby (NO in Act 6), the CPU 11 terminates the job confirmation process as an error.

When the status of a print job is standby (YES in Act 6), the CPU 11 obtains the job management data of the selected print job from the job management table 32 (Act 7). Based on the contents of the obtained job management data, the CPU 11 displays the job setting change screen 60 on the display 21. The CPU 11 accepts changes in the output size, double-sided print mode, and N-up printing mode, which are the attributes of the image data managed by the job management data (Act 8). The CPU 11 has functions as an attribute change acceptance unit 111.

FIG. 6 shows an example of the job setting change screen 60. As shown in FIG. 6, the job setting change screen 60 has an output size selection box 61, a double-sided printing mode selection box 62, an N-up printing mode selection box 63, and an end button 64.

The output size selection box 61 displays an output size of job management data as a default value. The double-sided printing mode selection box 62 displays information about double-sided printing mode (Yes or No) of the job management data, as a default value. The N-up printing mode selection box 63 displays “No”, as a default value.

When a pull-down mark 61a of the output size selection box 61 is touched, a list of selectable output sizes is displayed as a pull-down menu. When any one of the items of the pull-down menu is touched, the selected item is displayed in the selection box 61. This is the same for the double-sided printing mode selection box 62 and N-up printing mode selection box 63.

When the job setting change screen 60 is displayed, the CPU 11 waits until the end button 64 on the screen is touched (Act 9). When the end button 64 is touched (YES in Act 9), the CPU 11 determines whether the output size of the job setting change screen 60, double-ended printing mode, or N-up printing mode is changed (Act 10). When nothing is changed (NO in Act 10), the CPU 11 clears the job setting change screen 60 (Act 17).

If any item is changed (YES in Act 10), the CPU 11 confirms the changed item (Acts 11, 13 and 15). If the output size is changed (YES in Act 11), the CPU 11 rewrites the output size of the obtained job management data to the output size of the item displayed in the output size selection box 61 (Act 12). It should be noted here that the CPU 11 functions as an attribute information rewrite unit 112.

When the setting of N-up printing mode is changed (YES in Act 13), the CPU 11 changes the image data of the print job managed by the obtained job management data, based on the contents of the changed N-up printing mode (Act 14).

When the setting of double-sided printing mode is changed (YES in Act 15), the CPU 11 changes the image data of the print job managed by the job management data the contents of obtained from the job management table 32, based on the changed double-sided printing mode (Act 16).

Then, the CPU 11 clears the job setting change screen 60 (Act 17). This completes the job confirmation process.

The MFP 1 according to the embodiment has an image file 31 as storage to store image data of documents of multiple pages. The CPU 11 reads the image data of documents stored in the image file 31 for predetermined time, and compiles the read document data into one print unit. Based on the image data compiled in one print unit, the CPU 11 forms an image in a recording medium. Therefore, the number of printing can be reduced to smaller than the number of image data of documents, and energy can be saved.

The MFP 1 has a function as an attribute change acceptance unit 111. In other words, when the user touches the job confirmation button 23, the screen of the display 21 is changed to the job list screen 50. The job list screen 50 displays the job management list 51, based on the contents of the job management data corresponding to each image data stored in the image file 31. When the user selects a print job from the list 51, and touches the setting change button 53, the screen of the display 21 is changed to the setting change screen 60 for the selected print job.

If the user selects 2-up printing mode by touching the N-up printing mode selection box 63, the 2-up printing is executed for the image data of the selected print job.

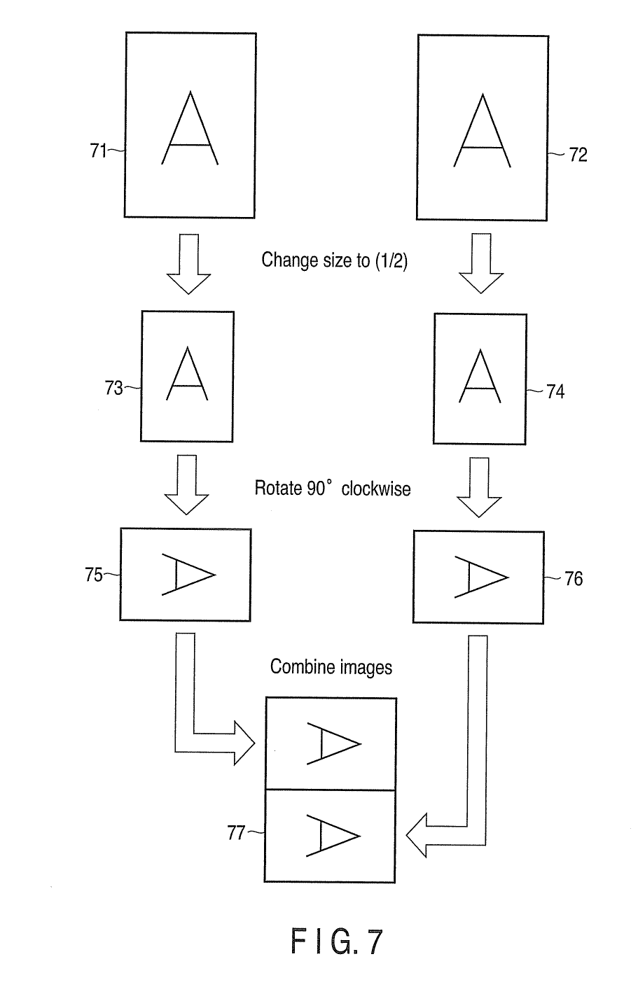

FIG. 7 shows changes of image data when changing to 2-up printing is executed. When the changing to 2-up printing is started, the CPU 11 first detects an image file name of first page from the corresponding job management data. The CPU 11 reads the image data 71 of the detected file name from the image file 31. Then, the CPU 11 detects an image file name of second page from the same job management data. The CPU 11 reads the image data 72 of the detected file name from the image file 31.

Next, the CPU 11 applies the image data 71 and 72 to the image converter 18. The CPU 11 operates the image scaling unit 42, and reduces the image data 71 and 72 to half size. The CPU 11 operates the image rotation unit 41, and rotates the reduced image data 73 and 74 90° clockwise.

Next, the CPU 11 combines the reduced and 90° rotated image data 75 and 76, to form each image separately on one side of the output size document. The CPU 11 saves the combined image data 77 in the image file 31, as first page image data of the corresponding print job.

Thereafter, similar to the above, the CPU 11 reduces image data of two continued pages to half size, rotates 90° clockwise, combines them, and sequentially saves in the image file 31, as image data of one page.

As described above, of the image data saved in the image file 31, the images of two continued pages are reduced to half size, and collectively printed on one side of a recording medium.

Next, the user changes “not double-sided” to “double-sided” by touching the double-sided printing mode selection box 62. Then, the image data of the corresponding print job is printed in double-sided mode.

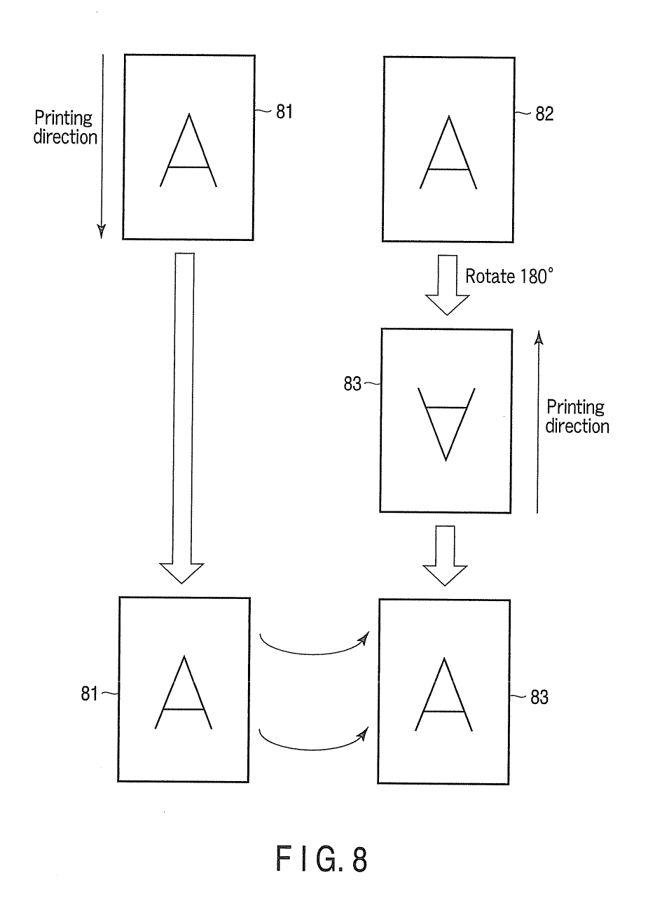

FIG. 8 shows changes of image data when changing to double-sided printing is executed. It is assumed that the MFP 1 forms images on the first side of a recording medium, reverses the recording medium, and forms another image on the second side, or the back of the recording medium.

When the changing to double-sided printing is started, the CPU 11 first detects an image file name of second page from the corresponding job management data. Then, the CPU 11 reads the image data 82 of the detected file name from the image file 31. In FIG. 8, the image data 81 is image data given the name of an image file of first page.

Next, the CPU 11 applies the image data 82 to the image converter 18. The CPU 11 operates the image rotation unit 41, and rotates the image data 82 by 180°.

Next, the CPU 11 saves the 180° rotated image data 83 in the image file 31 as second page image data of the corresponding print job.

Thereafter, similar to the above, the CPU 11 rotates the image data of the even number page of two continued pages by 180°, and saves the image data in the image file 31 as the same page image data.

As described above, of the image data saved in the image file 31, the images of two continued pages of document are printed alternately on one side and the other opposite side of a recording medium.

Even if the user changes “double-sided” to “not double-sided”, the MFP 1 can follow the change by converting the image data by rotating the even number page image data by 180° as described above.

As described herein, the MFP 1 of the embodiment can change the image data according to the change in the image data attributes stored in the image file 31. Therefore, even if a print request is issued without setting printing mode, double-sided or N-up, the user can follow the change without canceling the print request.

The invention is not limited to the embodiment described herein. The invention may be embodied by modifying the constituent elements without departing from the essential characteristics.

For example, in the embodiment described herein, the MFP 1 having the electrophotographic image formation unit 17 has been explained. The embodiment is not limited to such a MFP 1. The embodiment may be applied to any other image formation apparatus such as a laser printer and an ink-jet printer having storage to store image data of multiple pages of document.

Further, in the embodiment described herein, information about double-sided and N-up printing is shown as attribute information for forming an image of two continued pages of document in a recording medium. The attribute information is not limited to such information.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image formation apparatus comprising:
a storage configured to store image data of multiple pages of document;
an image formation unit configured to read image data stored in the storage, and to form an image based on the image data in a recording medium;
an attribute change acceptance unit configured to accept a change instruction for changing attribute information used for forming images of continued pages of document in the recording medium;
an attribute information rewrite unit configured to rewrite the attribute information, based on the change instruction accepted by the attribute change acceptance unit; and
an image converter configured to convert image data stored in the storage, based on attribute information rewritten by the attribute information rewrite unit.

2. The apparatus according to claim 1, wherein the change instruction accepted by the attribute change acceptance unit comprises information for reducing images of continued pages of document and collecting the images on one side of the recording medium.

3. The apparatus according to claim 2, wherein when the attribute change acceptance unit accepts a change instruction for reducing images of continued pages of document and collecting the images on one side of the recording medium, the image converter converts the image data so that the images of continued pages of document are reduced and collected on one side of the recording medium.

4. The apparatus according to claim 1, wherein the change instruction accepted by the attribute change acceptance unit is information for forming images of continued pages of document alternately on a first side and a second opposite side of the recording medium.

5. The apparatus according to claim 4, wherein when the attribute change acceptance unit accepts a change instruction for forming images of continued pages of document alternately on a first side and a second opposite side of the recording medium, the image converter converts the image data so that images of continued pages of document are formed alternately on first and second sides of the recording medium.

6. The apparatus according to claim 1, wherein the attribute change acceptance unit accepts a change instruction in attribute information for image data selected from image data stored in the storage, and
the image converter converts the image data selected from image data stored in the storage.

7. The apparatus according to claim 6, wherein the change instruction accepted by the attribute change acceptance unit comprises information for reducing images of continued pages of document and collecting the images on one side of the recording medium.

8. The apparatus according to claim 7, wherein when the attribute change acceptance unit accepts a change instruction for reducing images of continued pages of document and collecting the images on one side of the recording medium, the image converter converts the image data so that the images of continued pages of document are reduced and collected on one side of the recording medium.

9. The apparatus according to claim 6, wherein the change instruction accepted by the attribute change acceptance unit comprises information for forming images of continued pages of document alternately on a first side and a second opposite side of the recording medium.

10. The apparatus according to claim 9, wherein when the attribute change acceptance unit accepts a change instruction for forming images of continued pages of document alternately on a first side and a second opposite side of the recording medium, the image converter converts the image data so that images of continued pages of document are formed alternately on first and second sides of the recording medium.

11. An image formation method, comprising:
storing image data of multiple pages of document in storage;
reading image data stored in the storage, and forming an image based on the image data in a recording medium, by an image formation unit;
accepting a change instruction for changing attribute information used for forming images of continued pages of document in the recording medium, by an attribute change acceptance unit;
rewriting attribute information by an attribute information rewrite unit, based on the change instruction accepted by the attribute change accepting unit; and
converting image data stored in the storage, based on attribute information rewritten by the attribute information rewrite unit.

12. The method according to claim 11, wherein the change instruction accepted by the attribute change acceptance unit comprises information for reducing images of continued pages of document and collecting the images on one side of the recording medium.

13. The method according to claim 12, wherein when the attribute change acceptance unit accepts a change instruction for reducing images of continued pages of document and collecting the images on one side of the recording medium, the image data is converted so that the images of continued pages of document are reduced and collected on one side of the recording medium.

14. The method according to claim 11, wherein the change instruction accepted by the attribute change acceptance unit is information for forming images of continued pages of document alternately on a first side and a second opposite side of the recording medium.

15. The method according to claim 14, wherein when the attribute change acceptance unit accepts a change instruction for forming images of continued pages of document alternately on a first side and a second opposite side of the recording medium, the image data is converted so that images of continued pages of document are formed alternately on first and second sides of the recording medium.
